(19) United States
(12) Patent Application Publication
(10) Pub. No.: US 2005/0037663 A1
(43) Pub. Date: Feb. 17, 2005

(54) Vehicle mounted electrical outlet box

(75) Inventors: Kazushi Matsukawa, Ichishi-gun (JP); Masaru Yoshida, Taki-gun (JP); Masuo Kitamura, Tsu-shi (JP)

Correspondence Address: GREENBLUM & BERNSTEIN, P.L.C., 1950 ROLAND CLARKE PLACE, RESTON, VA, 20191, US

(73) Assignee: Matsushita Electric Works, Ltd., Osaka (JP)

(21) Appl. No.: 10/912,037

(22) Filed: Aug. 6, 2004

(30) Foreign Application Priority Data
Aug. 8, 2003 (JP) 2003-290717

(51) Int. Cl. H01R 4/50

(52) U.S. Cl. 439/535

(57) ABSTRACT

A compact vehicle-mounted electrical outlet box offering a reliable plug blade detection function. The electrical outlet box is formed from synthetic resin rectangular case 1 which includes body 2 and cover 3. A pair of electrical plug blades 100 and 101 are inserted into plug blade insertion slots 5 located on the front surface of case 1 through which the plug blades contact two blade receiver parts 10. The forceful contact of plug blades 100 and 101 rotate two pivot levers 12 which convert the insertion force of plug blades 100 and 101 to a directional force. Two return springs 13 apply pressure to pivot levers 12 in a direction opposite to that applied by the insertion of plug blades 100 and 101. Printed circuit block 14, which is comprised of circuit base plate 14a to which each microswitch 14b is installed, is housed within case 1. The two pivot levers 12 are located at the approximate mid-point of body 2 between the two mutually facing blade receiver parts.

### BACKGROUND OF THE INVENTION

1. Field of the Invention

The invention relates to a vehicle mounted electrical outlet box incorporating a switch that detects the presence of plugged in terminal blades.

2. Description of the Background Information

Automotive vehicles have recently being equipped with onboard electrical outlet boxes that allow the use of electrical appliances in the vehicle. These vehicle mounted electrical outlet boxes are able to detect the presence of plug in terminal blades that have been inserted to the outlet. Japanese Kokai (laid open) Patent No. 2000-301991, and particularly paragraphs 0016-0022,0030 and 0031; and FIGS. 1-5, show a conventional automotive electrical outlet box.

Conventional vehicle-mounted electrical outlet boxes of the type noted above require that a plug blade detecting switch be mounted external to the outlet box, thus increasing the size of the outlet box and detracting from its external appearance. Further, the detecting switch does not operate with complete reliability as it may activate the blade detection switch to an “on” state even though the blades may not have been inserted into the outlet. Also, the detecting switch may operate erroneously as a result of vibration or the plug being inserted at an inclined orientation.

### SUMMARY OF THE INVENTION

Taking at least the above-noted shortcomings into consideration, the present invention provides a more compact vehicle mounted electrical outlet box that incorporates a reliable plug blade detecting device.

An aspect of the present invention provides a vehicle mounted electrical outlet box including a case including a pair of plug blade insertion slots configured to receive a pair of plug blades inserted therein; a pair of blade receiver portions electrically connected to an electrical power source of the vehicle, the blade receiver portions configured to contact plug blades inserted into the case through the plug blade insertion slots; a pair of plug blade detection mechanisms configured to detect the presence of each plug blade inserted into each the plug blade insertion slot; and a pair of sensor switches, each the sensor switch including ‘on’ and ‘off’ switching contact points that operate in response to detection of the presence of a plug blade by the detection mechanism; wherein the detection mechanisms are located between opposing blade receiver portions, and the contact points of each sensor switch are electrically wired together in a series configuration. IN a further aspect of the present invention, each plug blade insertion detection mechanism includes a pivot lever configured to pivot from the insertion of the plug blades into the plug blade insertion slots, each the pivot lever including a pivot shaft pivotably supported by the case, an inclined blade sensor surface through which plug blade insertion force is converted to a directional force that intersects the plug blade insertion direction, and a switch operating part driven by the directional force in order to operate the sensor switches when the pivot lever pivots, wherein the axial ends of aid pivot shaft are formed in an approximately oval shape. In a further aspect of the present invention, each plug blade insertion detection mechanism includes a pivot lever configured to pivot from the force with which the plug blades are inserted into the plug blade insertion slots, each pivot lever including a pivot shaft pivotably supported by the case, an inclined blade sensor surface through which the plug blade insertion force is converted to a directional force that intersects the plug blade insertion direction, and a switch operating part driven by the directional force in order to operate the sensor switches when the pivot lever pivots, wherein the blade receiver part includes a stop flange that presses against the pivot shaft of the pivot lever in order to maintain the pivot lever in a fixed position.

Further, each plug blade insertion detection mechanism may include a pivot lever configured to pivot from the force with which the plug blades are inserted into the plug blade insertion slots, each pivot lever including a pivot shaft pivotably supported by aid case, an inclined blade sensor surface through which the plug blade insertion force is converted to a directional force that intersects the plug blade insertion direction, and a switch operating part driven by the directional force in order to operate the sensor switches when the pivot lever pivots, wherein a return spring applies pressure against the pivot lever in a direction opposite to that in which the pivot lever is pivotably moved by the plug blade insertion force. Further, each plug blade insertion detection mechanism may include a pivot lever configured to pivot from the force with which the plug blades are inserted into the plug blade insertion slots, each pivot lever including a pivot shaft pivotably supported by the case, and an inclined blade sensor surface that changes the plug blade insertion force to a directional force that intersects the plug blade insertion direction, and a switch operating part which is driven by the directional force in order to operate the sensor switches when the pivot lever pivots, wherein a pivot recess is formed within an internal wall in the case in order to pivotably support the pivot shaft, and a metal plate is provided to cover and conceal the pivot recess in order to provide a surface on which the surface of the pivot lever, on which the pivot shaft is formed, may slide. The metal plate thus provides an unhindered sliding surface that prevents the pivot lever from hanging up on the edge of the pivot recess.

In a further aspect of the present invention, each plug blade insertion detection mechanism may include a pivot lever configured to pivot from the force with which the plug blades are inserted into the plug blade insertion slots, each pivot lever including a pivot shaft pivotably supported by the case, an inclined blade sensor surface that changes the plug blade insertion force to a directional force that intersects the plug blade insertion direction, and a switch operating part which is driven by the directional force in order to operate the sensor switches when the pivot lever pivots, wherein a stop notch formed on the pivot lever contacts a surface within the case at a time when the plug blades are not present in the blade insertion slots, the contact occurring in a pivoting direction opposite to that induced by the directional force. Further, the stop notch is formed on both ends of the pivot lever on the radial axis thereof. A structure able to stop the reverse pivoting movement of the pivot lever in order to provide a more stable detection function. In a further aspect of the present invention, each plug blade insertion detection mechanism may include a pivot lever configured to pivot from the force with which the plug blades are inserted into the plug blade insertion slots, each pivot lever including a pivot shaft pivotably supported by the case, an inclined blade sensor surface that changes the plug blade insertion force to a directional force that intersects the plug blade insertion direction, and a switch operating part driven by the directional force in order to operate a sensor switch, which is mounted to a base plate, when the pivot lever pivots from the directional force, wherein the case and base plate are joined through a connection of mutually indexed recessed notches and projecting tabs formed on the case and base plate. Further the vehicle mounted electrical outlet box may include an indicator lamp to indicate when electricity is being supplied. Further, the case is formed of a synthetic resin. Further, the blade receiver portions are made from a flexible electrically conductive material. The blade receiver portions may be configured to press plug blades inserted into the case through the plug blade insertion slots. The blade receiver portions may be configured to forcefully contact plug blade inserted into the case through the plug blade insertion slots.

As noted previously, the vehicle-mounted electrical outlet box invention can be made to more compact dimensions due to the detection mechanisms being located between the two blade receivers which contact the plug blades. Furthermore, the contact points that operate according to the insertion of each plug blade are electrically wired in series so as to activate the detection function only when both plug blades have been inserted. This construction provides a device and method of preventing the insertion of one plug blade, which may result from mischief of other factors, from activating the detection function, and promotes stable operation of the detection function to improve reliability.

### BRIEF DESCRIPTION OF THE DRAWINGS

The above, and other objects, features and advantages of the present invention will be made apparent from the following description of the preferred embodiments, given as nonlimiting examples, with reference to the accompanying drawings in which:

FIG. 1 is an exploded perspective view of the electrical outlet box of the embodiment of the present invention;

FIG. 2a is a front elevational view of the electrical outlet box of the embodiment of FIG. 1;

FIG. 2b is a side elevational view of the electrical outlet box of the embodiment of FIG. 1;

FIG. 2c is a plan view of the electrical outlet box of the embodiment of FIG. 1;

FIG. 2d is a rear view of the electrical outlet box of the embodiment of FIG. 1;

FIG. 3 is a front elevational view of the electrical outlet box of the embodiment of FIG. 1, with the external cover open;

FIG. 4a is a cross sectional view of the blade side of the electrical outlet box of the embodiment of FIG. 1, before insertion of the plug blades;

FIG. 4b is a cross sectional view of the switch side of the electrical outlet box of the embodiment of FIG. 1, before insertion of the plug blades;

FIG. 5a is a cross sectional view of the blade side of the electrical outlet box of the embodiment of FIG. 1, during insertion of the plug blades;

FIG. 5b is a cross sectional view of the switch side of the electrical outlet box of the embodiment of FIG. 1, during insertion of the plug blades;

FIG. 6a is a cross sectional view of the blade side of the electrical outlet box of the embodiment of FIG. 1, after insertion of the plug blades;

FIG. 6b is a cross sectional view of the switch side of the electrical outlet box of the embodiment of FIG. 1, after insertion of the plug blades;

FIG. 7 is a front elevational view of the body portion of the embodiment of FIG. 1;

FIG. 8 is a side elevational view of the body portion of the embodiment of FIG. 1;

FIG. 9 is a rear elevational view of the body portion of the embodiment of FIG. 1;

FIG. 10 is a plan view of the body portion of the embodiment of FIG. 1;

FIG. 11 is a cross sectional view of the body portion of the embodiment of FIG. 1, from line A-A in FIG. 7.

FIG. 12 is a front elevational view of the cover portion of the embodiment of FIG. 1;

FIG. 13 is a plan view of the cover portion of the embodiment of FIG. 1;

FIG. 14 is a side elevational view of the cover portion of the embodiment of FIG. 1;

FIG. 15 is a rear elevational view of the cover portion of the embodiment of FIG. 1;

FIG. 16 is a cross sectional view of the cover of the embodiment of FIG. 1, from line B-B in FIG. 12;

FIG. 17 is a rear elevational view of the external cover portion of the embodiment of FIG. 1;

FIG. 18 is a cross sectional view of the external cover portion of the embodiment of FIG. 1;

FIG. 19 is a front elevational view of the external cover portion of the embodiment of FIG. 1;

FIG. 20 is a cross sectional view of the external cover portion of the embodiment of FIG. 1;

FIG. 21 is a front elevational view of the blade receiver portion of the embodiment of FIG. 1;

FIG. 22 is a left side elevational view of the blade receiver portion of the embodiment of FIG. 1;

FIG. 23 is a plan view of the blade receiver portion of the embodiment of FIG. 1;

FIG. 24 is a rear elevational view of the blade receiver portion of the embodiment of FIG. 1;

FIG. 25a is a front view of the pivot lever portion of the embodiment of FIG. 1;

FIG. 25b is side view of the pivot lever portion of the embodiment of FIG. 1;

FIG. 25c is a plan view of the pivot lever portion of the embodiment of FIG. 1;

FIG. 26 is a front elevational view of the return spring portion of the embodiment of FIG. 1;

FIG. 27 is a side view of the return spring portion of the embodiment of FIG. 1;

FIG. 28 is a plan view of the return spring portion of the embodiment of FIG. 1;

FIG. 29 is a front view of the printed circuit block of the embodiment of FIG. 1;

FIG. 30 is a side view of the printed circuit block of the embodiment of FIG. 1;

FIG. 31 is a rear view of the printed circuit block of the embodiment of FIG. 1;

FIG. 32a is a plan view of the installed pivot lever portion of the embodiment of FIG. 1;

FIG. 32b is a front view of the installed pivot lever portion of the embodiment of FIG. 1;

FIG. 32c is a side view of the installed pivot lever portion of the embodiment of FIG. 1;

FIG. 33 is a perspective view of the sliding movement of the pivot lever and return spring of the embodiment of FIG. 1;

FIG. 34 is a perspective view of a second configuration of a pivot lever portion;

FIG. 35 is a perspective view of the pivot lever portion of the embodiment of FIG. 1;

FIG. 36 is a cross sectional view of the stop notch portion that limits the pivoting movement of the pivot lever of the embodiment of FIG. 1;

FIG. 37 illustrates how the pivot lever can be turned around for common use;

FIG. 38 is a cross sectional view of the stop flange portion of the pivot lever portion of the embodiment of FIG. 21;

FIG. 39 is a cross sectional view of a second configuration of a stop flange portion of the pivot lever part of the embodiment of FIG. 21;

FIG. 40 is a cross sectional view of a third configuration of a stop flange portion of the pivot lever part of the embodiment of FIG. 21;

FIG. 41 is a plan view of the printed circuit block installed in the body of the embodiment of FIG. 21;

FIG. 42 is a schematic drawing of the printed circuit block circuit structure of the embodiment of FIG. 21;

FIG. 43 is a plan view of the embodiment of FIG. 21, with the outer cover in the open position;

FIG. 44a is a plan view of another embodiment of FIG. 21, with the outer cover in the open position; and

FIG. 44b is a plan view of the embodiment of FIG. 44a, with the outer cover in the closed position.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

The following will describe embodiments of the invention with reference to the drawings.

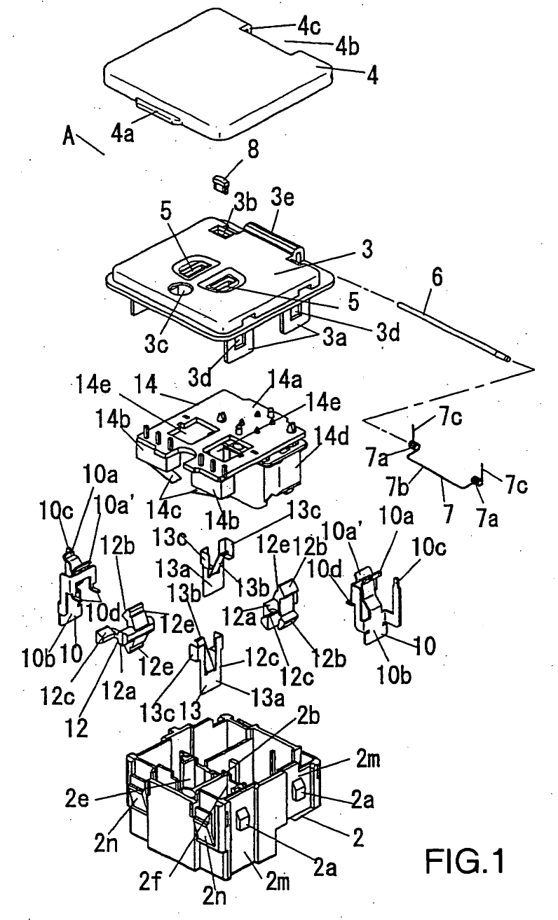

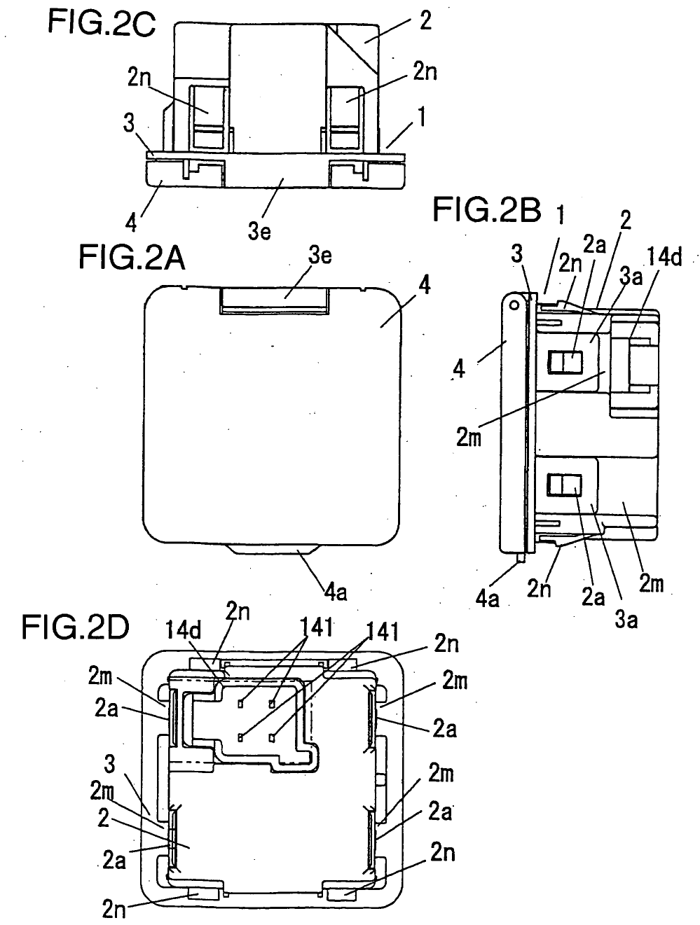

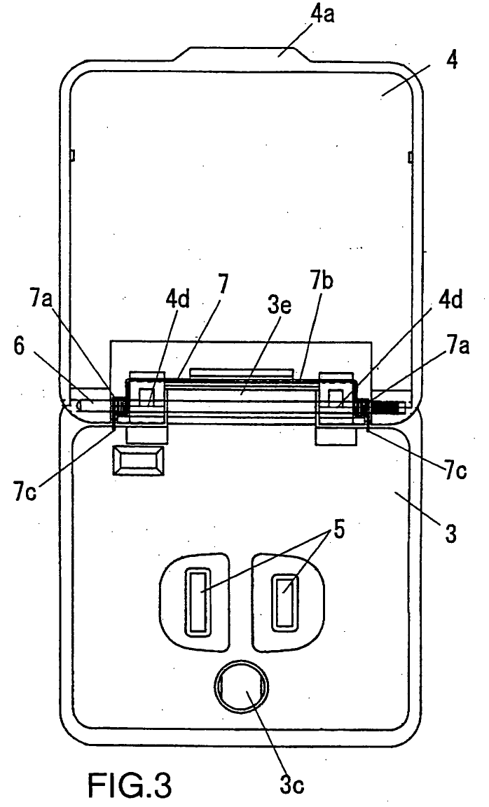

As illustrated in FIGS. 1 through 3, the electrical outlet box of the present invention includes case 1 which is formed from the joining of body 2 and cover 3, and external cover 4 which pivots on one edge of case 1 to positions that expose or cover the front surface of cover 3 (the upper surface of cover 3 as shown in FIG. 1). The case 1 may have any suitable form and in the present embodiment has a rectangular shape. The body 2 may formed from any suitable material such as, for example, a synthetic resin.

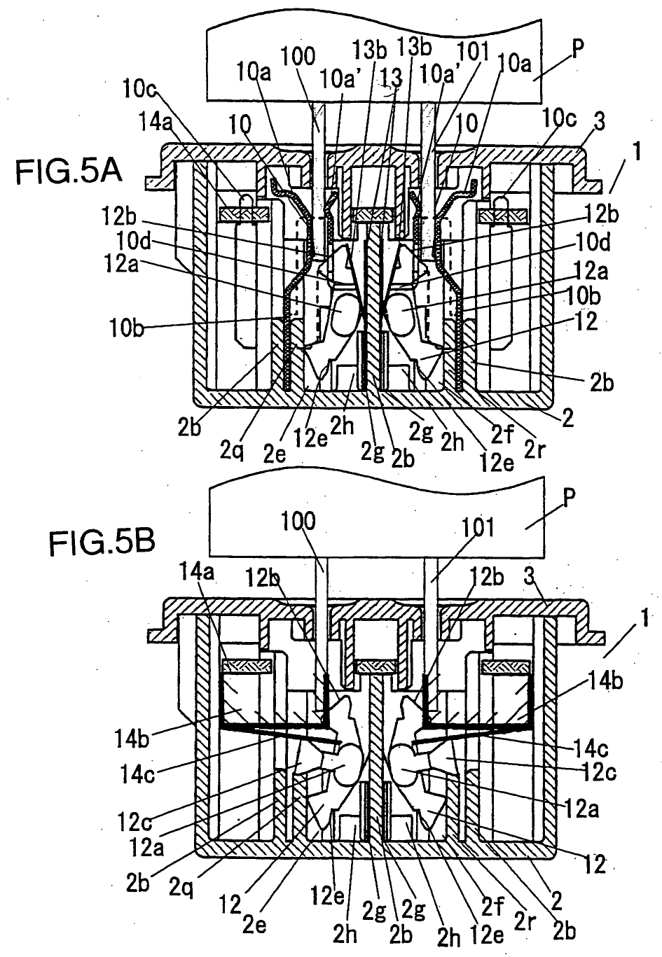

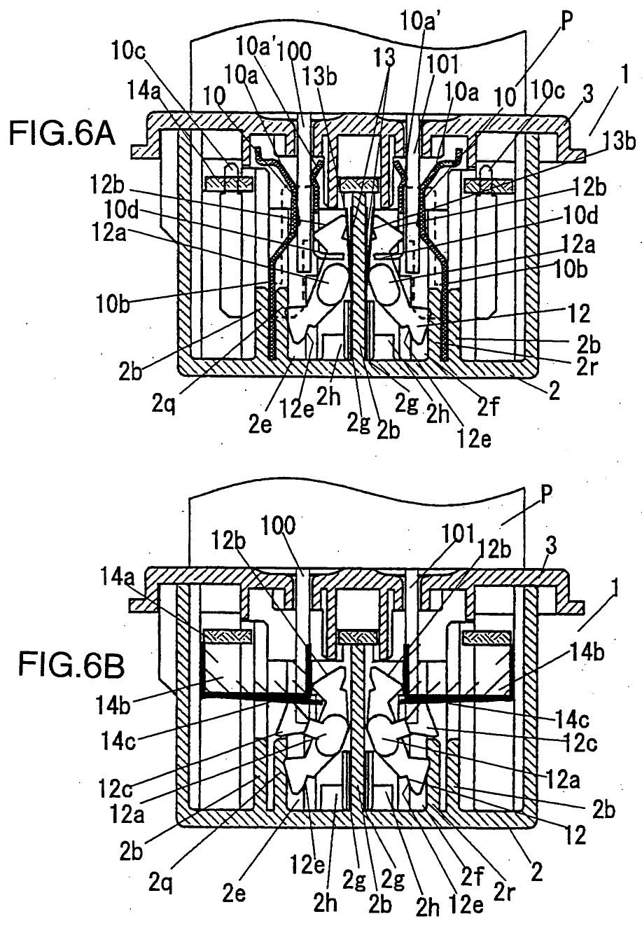

Body 2, which in the present embodiment is a rectangular structure with an open front portion, houses two blade receivers 10 that contact voltage plug blade 100 and ground plug blade 101, respectively, of plug ‘P’ (shown in FIGS. 5a, 5b, 6a, and 6b) which are inserted through blade insertion slots 5 on cover 3, a pair of pivot levers 12 that pivot in one direction through respective contact with plug blades 100 and 101 inserted through plug blade insertion slots 5, a pair of return springs 13 that apply pressure against respective pivot levers 12 in the opposite direction to that in which the levers pivot through contact with plug blades 100 and 101, printed circuit block 14 which includes two microswitches 14b, each microswitch being equipped with lever 14c attached at one edge thereon in order to detect the pivoting movement of each pivot lever 12, and circuit base plate 14a to which connector 14d is attached, connector 14d serving as a signal terminal part to which external electrical wires are connected.

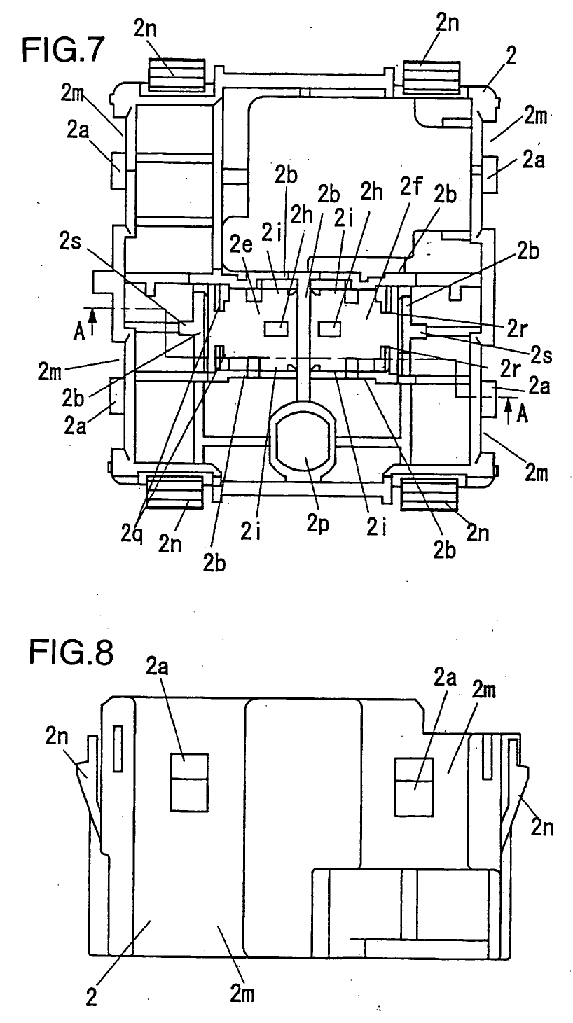

Cover 3 is attached to and covers the front of body 2. In this embodiment, the electrical outlet box is a structure formed in an operating relationship to plug ‘P’ which includes mutually opposing plate-shaped plug blades 100 and 101 and, as shown in FIG. 3, the outlet box includes two rectangular-shaped blade insertion slots 5 in parallel orientation. Moreover, dummy hole 3c is provided adjacent to blade insertion slots 5 in order to allow the insertion of plugs equipped with a round grounding pin. Cylindrical guide part 3f (FIG. 16) extends from the inner surface of cover 3 around dummy hole 3c, and guide hole 2p (FIG. 7) is formed in body 2 as a connecting passage to cylindrical guide part 3f.

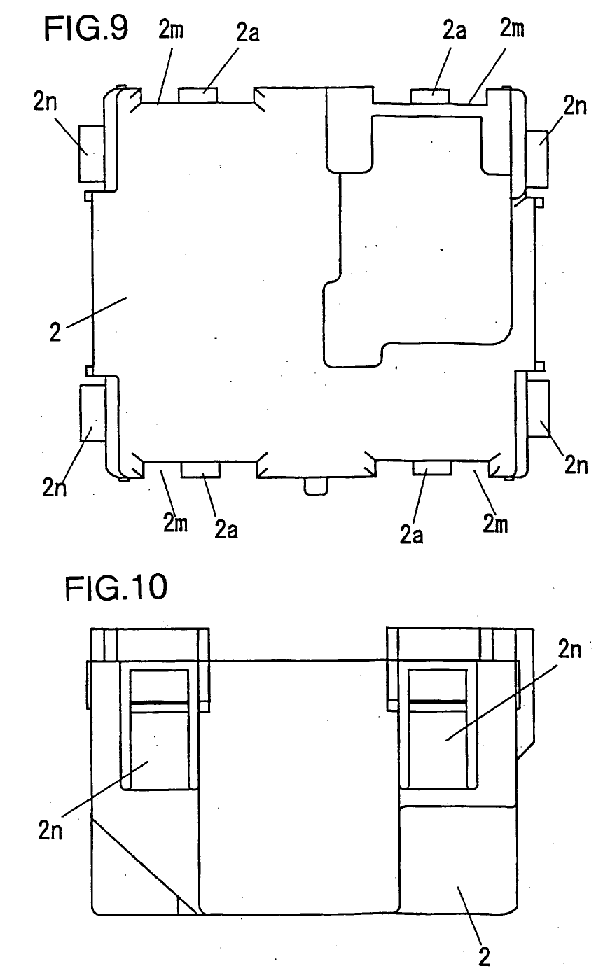

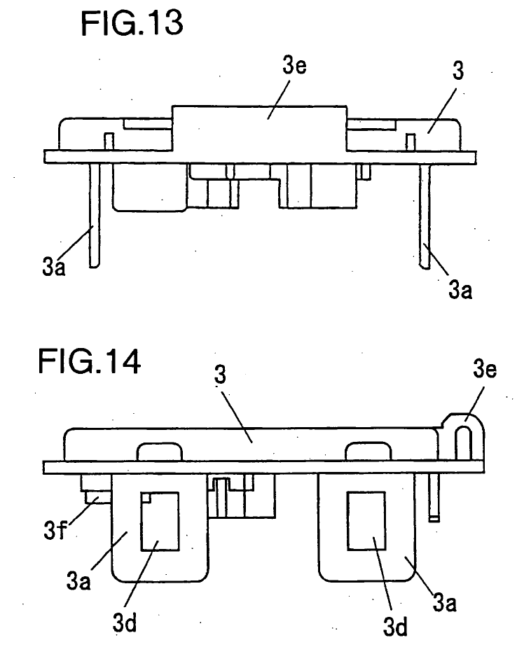

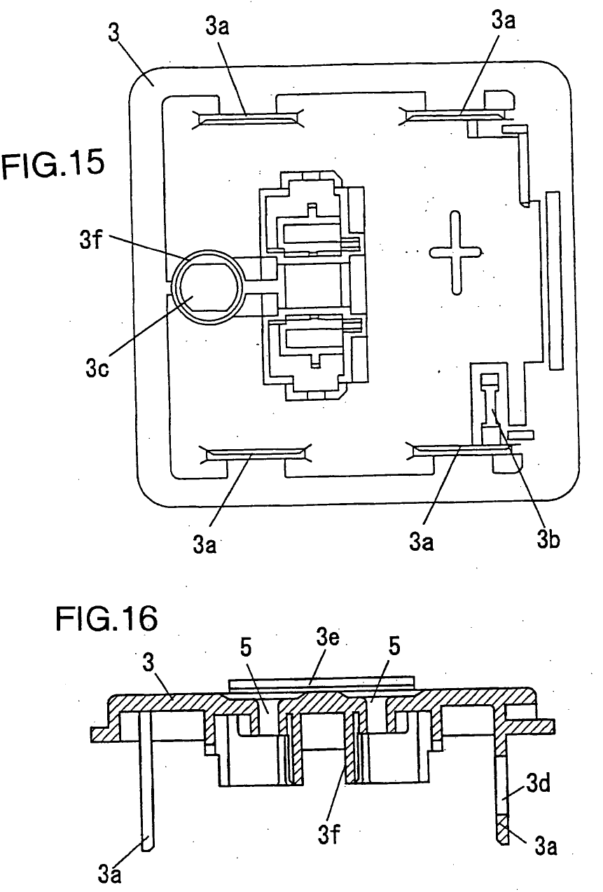

As shown in FIGS. 7 through 11, a pair of fore and aft extending assembly channels 2m (FIG. 8) are provided on two external sides of body 2, and assembly tab 2a projects from the bottom part of each channel 2m. As can be seen in FIGS. 12 through 16, a pair of rearward extending assembly latches 3a project from two edges of cover 3. Each aperture 3d, which is formed within each latch 3a, joins to each assembly tab 2a. Therefore, pressing cover 3 over body 2 results in each assembly tab 2a joining to an opposing aperture 3d to mutually connect cover 3 and body 2. With cover 3 and body 2 mutually joined, the edges of cover 3 extend outward over and beyond each side of body 2.

A pair of assembly lips 2n are formed on each of the two sides of body 2 not having assembly channels 2m. Case 1 may be provided in a panel (not shown) by insertion, from the body 2 side, into a rectangular mounting hole (not shown) provided in the panel and formed to the approximate dimensions of the external dimensions of body 2. The edge of the mounting hole is sandwiched between lips 2n and the edges of cover 3 to fixedly secure case 1 to the panel.

Moreover, hinge support 3e, into which hinge pin 6 is inserted, is formed on the edge of one of the two sides of cover 3 on which assembly latches 3a are not formed. As can be seen in FIGS. 3 through 14, hinge support 3e is a U-shaped boss from which both ends of hinge pin 6 projects to be exposed on the front side of cover 3. Spring 7 is attached to hinge pin 6. Spring 7 is a single spring form that includes an integral spring coil 7a formed at each end, the two spring coils 7a being mutually connected by U-shaped connecting part 7b, and a spring arm 7c that radially extends from the external end of each spring coil 7a. This structure thus allows hinge pin 6 to be inserted through both spring coils 7a, connecting member 7b to contact the rear surface of external cover 4, and spring arms 7c to be secured against cover 3.

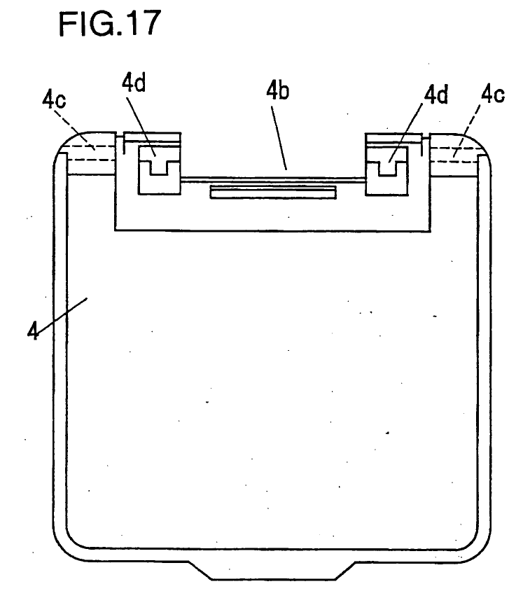

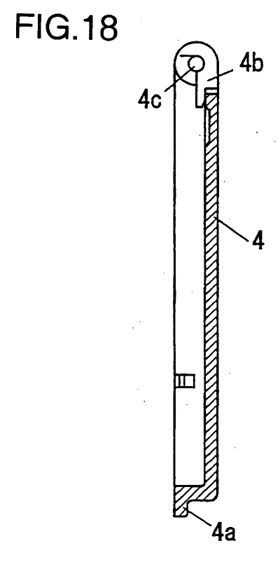

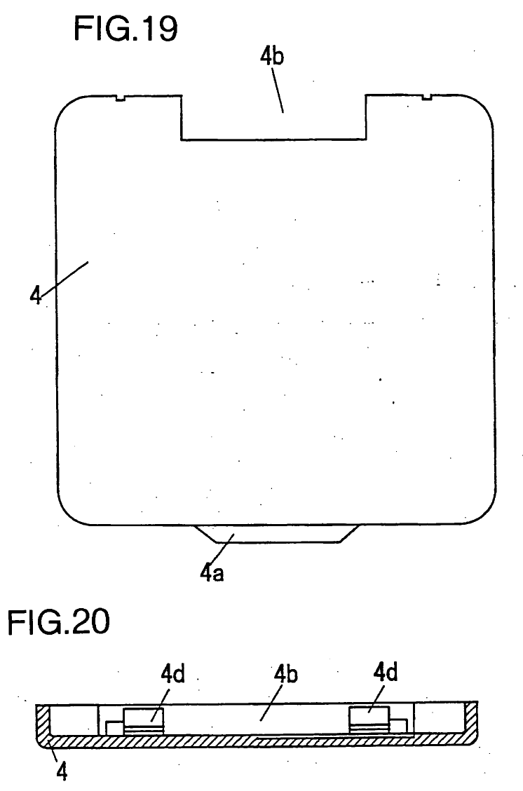

External cover 4 is formed in the approximate same external configuration as cover 3 but of a size able to cover the entire front surface of cover 3. As shown in FIGS. 17 through 20, cutout portion 4b, which is formed within the part of cover 4 that confronts hinge support 3e on cover 3, allows the placement of hinge support 3e therein. External cover 4 includes hinge bosses 4d, through which the ends of hinge pin 6 pass, formed on each side of cutout portion 4b, and pin apertures 4c, located to accommodate the ends of hinge pin 6, into which the ends of hinge pin 6 are inserted. Each spring coil 7a is located between hinge boss 4d and pin aperture 4c. This structure allows the pivotal mounting of external cover 4 to cover 3 with spring 7 applying pressure in the direction that external cover 4 closes against cover 3. Further, lip 4a is formed on the edge of cover 4, opposite to cutout portion 4b, in order to provide a finger contacting portion through which external cover 4 can be opened and closed.

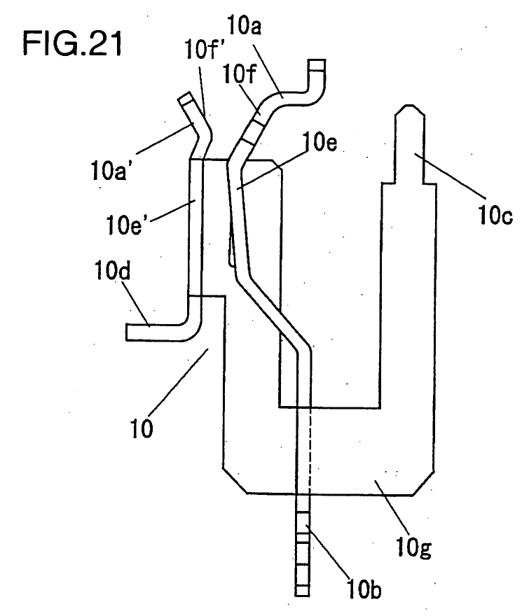

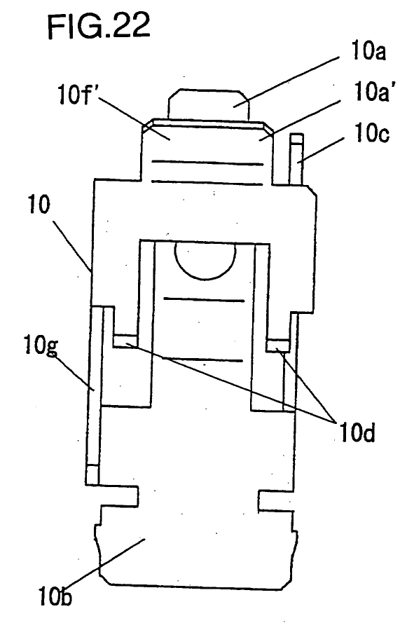

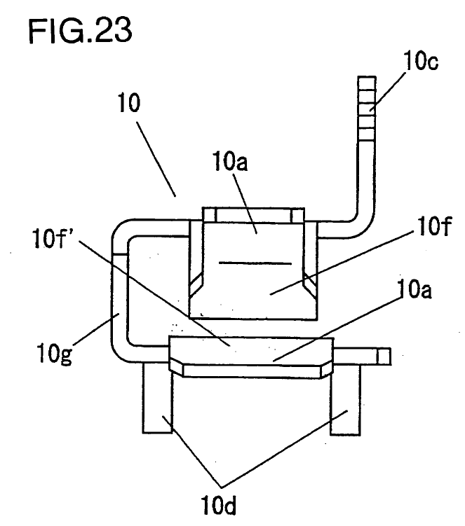

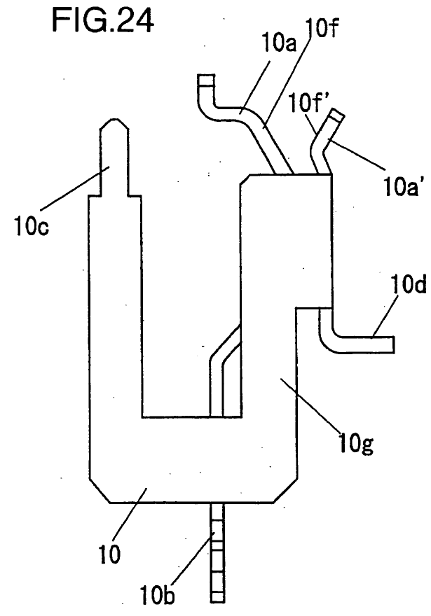

As shown in FIGS. 21 though 24, blade receiver 10, a single electrically conductive metal strip formed to include first blade spring 10a and second blade spring 10a′, is located adjacent to insertion slots 5 within case 1. Plug blades 100 and 101 are inserted into first and second blade springs 10a and 10a′ within case 1 through insertion slots 5. The following description will refer to the vertically oriented blade receiver 10 shown in FIG. 21. As shown in FIG. 21, the upper end of blade receiver 10 faces cover 3 from where plug blades 100 and 101 are inserted. Blade springs 10a and 10a′ include respective contact parts 10e and 10e′ that press against the center portions of plug blades 100 and 101, the upper extremities of contact parts 10e and 10e′ being respectively formed as inclined guide parts 10f and 10f′ which widen the space there between as they extend upward. Blade spring 10a includes insertion part 10b that extends beneath contact part 10e to a point below blade spring 10a′. Open space is provided below blade spring 10a′ with blade springs 10a and 10a′ being part of the same structure through their mutual connection by joint plate 10g. Joint plate 10g is an approximately L-shaped member that extends from the lower part of first blade spring 10a upward to contact part 10e′ of second blade spring 10a′, and serves as a connecting part that joins blade springs 10a and 10a′. Connector plate 10c is formed as an approximate L-shaped member extending upward opposite to joint plate 10g, the upper end of connector plate 10c extending into body 2 to make contact with circuit base plate 14a. Moreover, two stop flanges 10d, to be described subsequently, extend from the lower end of blade spring 10a′ in the opposite direction from blade spring 10a.

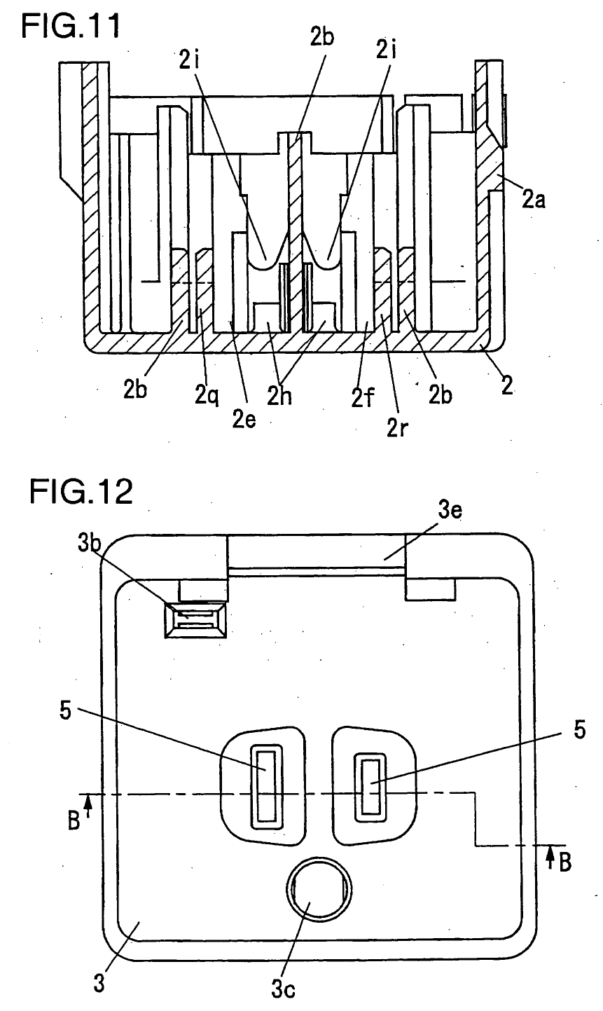

As illustrated in FIGS. 7 and 11, compartments 2e and 2f, which are located opposite blade insertion slots 5, are formed in the approximate center of the floor of body 2 by divider walls 2b which extend upward from the floor of body 2. Compartment 2e houses blade receiver 10 which conductively contacts voltage plug blade 100 when the blade is inserted through blade insertion slot 5, and voltage plug-side pivot lever 12 and return spring 13. Compartment 2f houses blade receiver 10 which conductively contacts grounding plug blade 101 when the blade is inserted through blade insertion slot 5, and grounding plug-side pivot lever 12 and return spring 13. Interval walls 2q, which project into compartment 2e, are aligned with divider wall 2b which is located on the side of body 2 on which assembly tabs 2a are formed, and interval walls 2r, which project into compartment 2f, are aligned with divider wall 2b which is located on the side of body 2 on which assembly tabs 2a are formed. Blade receivers 10 are located within body 2 through the insertion of their insertion parts 10b between divider wall 2b and interval walls 2q, and between divider wall 2b and interval walls 2r.

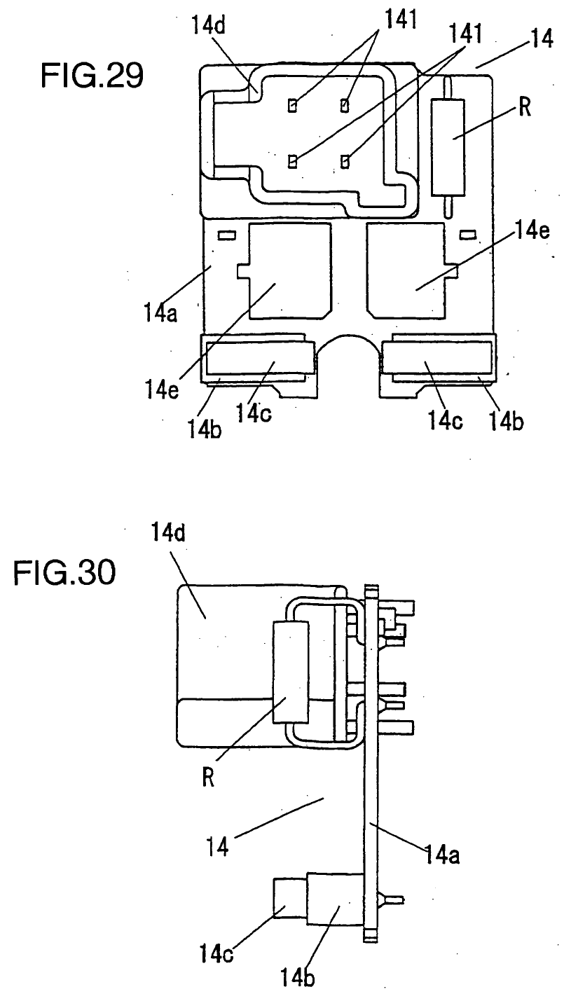

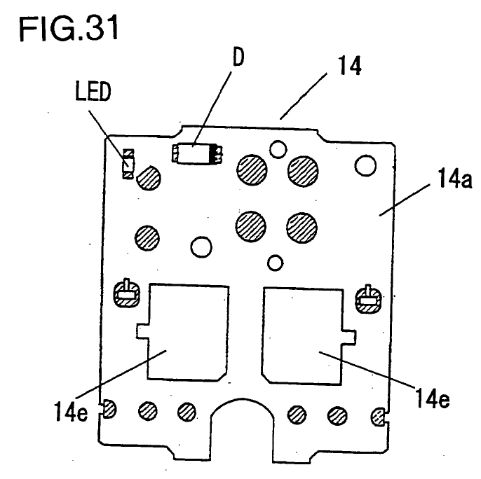

FIGS. 29 through 31 illustrate printed circuit block 14 which includes circuit base plate 14a as the printed circuit substrate, and two insertion apertures 14e into which blade receivers 10 are inserted. Microswitches 14b are installed at the perimeter of circuit base plate 14a adjacent to the part where each blade receiver 10 is inserted, and connecter 14d is installed at a different portion of circuit base plate 14a than microswitches 14b in order to provide a connecting part for external electrical wires. Microswitches 14b and connector 14d face the floor (rear surface) of body 2 when printed circuit base plate 14a is installed therein. The two microswitches 14b are electrically connected in series with the two ends of the series circuit connected to two terminals 141 of connector 14d. Further, electrical current is supplied to blade receiver 10 through the other two terminals 141 of connector 14d.

Each microswitch 14b is provided for the purpose of detecting the presence of plug ‘P’ blades 100 and 101 in their respective blade receiver 10 (see FIGS. 5a, 5b, 6a, 6b). Microswitch 14b is constructed so that pressure applied to the free end of lever 14c results in an actuator opening or closing internal contact points to respective ‘off’ or ‘on’ positions. In this embodiment, plug blades 100 and 101, when inserted into blade receivers 10, press against pivot lever 12, thus causing pivot lever 12, which is held in position by return spring 13, to pivot against the free end of lever 14c of microswitch 14, and thus pressurize the actuator.

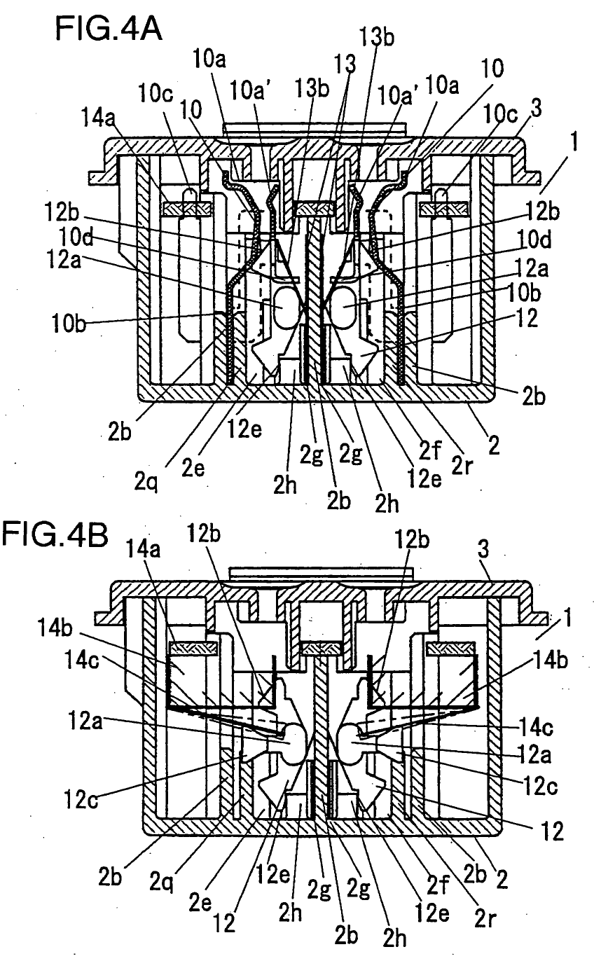

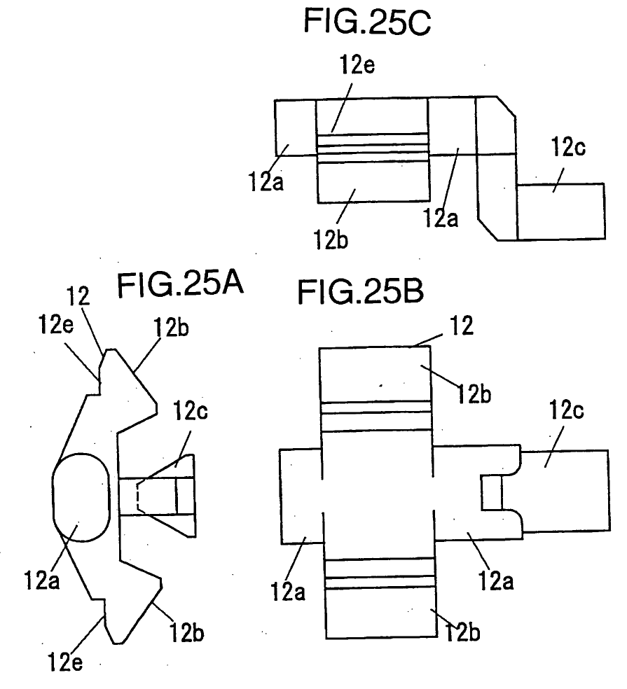

As illustrated in FIGS. 25a, 25b, and 25c, pivot lever 12 includes pivot shaft 12a, which is an oblong barrel-shaped shaft formed on both sides of pivot lever 12, around which pivot lever 12 rotates, switch operating part 12c which is an approximately L-shaped member that swings on the radial axis of pivot shaft 12a, and inclined blade sensor surfaces 12b which are symmetrically formed facing switch operating part 12c at the front and to the rear sides of pivot shaft 12a. Pivot lever 12, which is symmetrically formed in relation to pivot shaft 12a in the fore and aft directions, is provided in compartment 2e and 2f in the space opposite to insertion part 10b of blade receiver 10. As shown in FIGS. 4a and 4b, pivot shaft 12a is rotatably supported by body 2, and blade sensor surface 12b is exposed at the rear of the gap between blade springs 10a and 10a′ with switch operating part 12c in contact with lever 14c and microswitch 14b in an open state. As shown in FIG. 11, pivot lever 12 is housed within body 2 through the insertion of pivot shaft 12a into pivot recesses 2i, the upper side of pivot shaft 12a being exposed, and the lower side residing and being pivotable within pivot recesses 2i which gradually narrow.

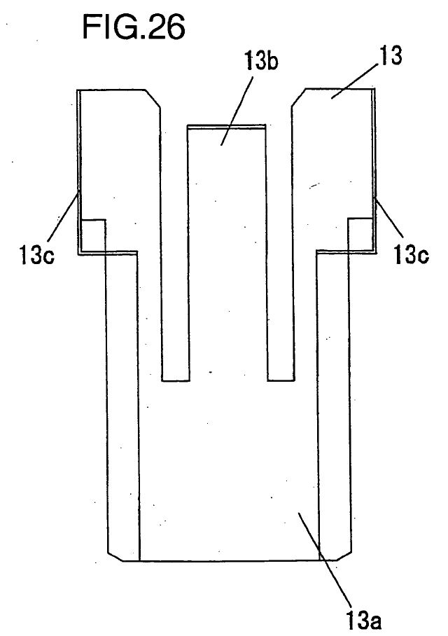

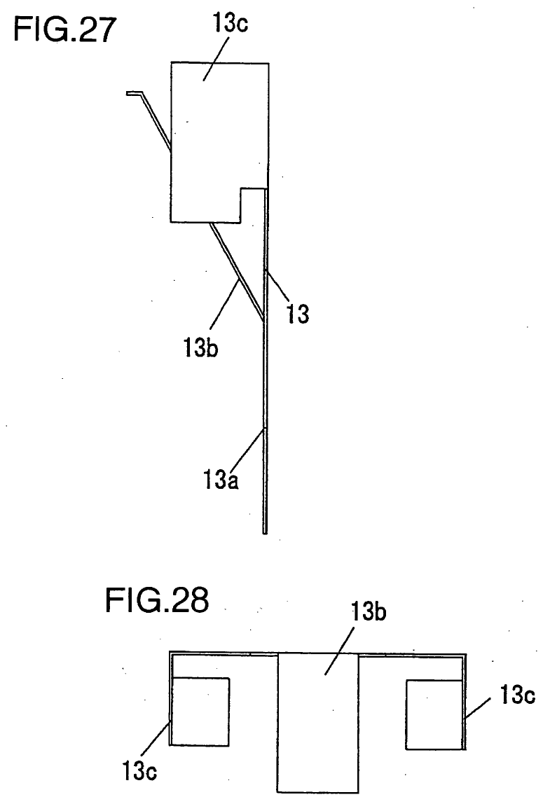

Return spring 13 (shown in FIGS. 4a, 4b, and 26 through 28) includes spring arm 13b which extends from the front edge of approximately rectangular-shaped spring base 13a, spring arm 13b bent in a direction toward pivot lever 12. Spring base 13a, which extends to the rear from spring arm 13b, is inserted into channel 2g which is formed along the rear portion of divider wall 2b that divides compartments 2e and 2f at the approximate mid-point of body 2. Thus installed, spring arm 13b maintains contact with the front part of oval-shaped pivot shaft 12a and the front part of pivot lever 12. Therefore, when plug blades 100 and 101 are not present in blade insertion slots 5, the pressure applied by spring arm 13b maintains pivot lever 12 at the ‘off’ position of lever 14c of sensor switch 14b. At this time, the force applied by return spring 13 is sufficient to prevent vibration and shocks from moving pivot lever 12.

The following will describe, with reference to FIGS. 5a, 5b, 6a, and 6b, the mechanisms that operate when plug blades 100 and 101 are inserted into blade insertion slots 5. Inserting plug blades 100 and 101 through blade insertion slots 5 and between spring blades 10a and 10a′ of each respective receiver blade 10 will bring plug blades 100 and 101 into contact with inclined sensor surfaces 12b on pivot levers 12. The tips of plug blades 100 and 101 press against inclined sensor surfaces 12b which convert the blade insertion force to an intersecting directional force (the horizontal direction as shown in FIGS. 5 and 6) that opposes the direction of pressure applied by return spring 13 to pivot lever 12, thus resulting in the top of pivot lever 12 pivoting toward the center of body 2 as inclined sensor surfaces 12b slide against plug blades 100 and 101. The vertically pivoting movement of pivot lever 12 moves switch operating part 12c against lever 14c of sensor switch 14b, thus pressing lever 14c to the ‘on’ position at which the contact points within sensor switch 14b close (see FIGS. 5a, 5b). Therefore, the complete insertion of plug blades 100 and 101 through each pair of blade springs 10a and 10a′ results in the further pivoting movement of pivot lever 12 which in turn pushes lever 14c of sensor switch 14b to the ‘on’ position at which the contact points in the switch close (see FIGS. 6a and 6b). Withdrawing plug blades 100 and 101 from blade insertion slots 5 results in return spring 13 pivotably pushing pivot levers 12 in the opposite direction to that when blades 100 and 101 were inserted, thus allowing lever 14c of sensor switch 14b to return to the ‘off’ position in which the contact points are open.

As previously noted, two microswitches 14b are provided, one at each of the two blade receivers 10, and the contact points of microswitches 14b are wired in series. To be more specific, output of the series-wired contact point circuit will activate when plug blades 100 and 101 are inserted into blade receivers 10, but the insertion of only one plug blade 100 or 101 (purposefully or not) into only one blade receiver 10 will prevent the circuit from activating. Moreover, because the activation signal sent to an external device through terminal connector 14d has been obtained from the series-wired contact point circuit that includes both microswitches 14b, that signal can be transmitted through only two terminals 141 even though the insertion condition of both plug blade 100 and 101 is monitored. The output signal is timed to activate when plug blades 100 and 101 are being withdrawn but are still in contact with blade receivers 10. In other words, the contact point operation of each microswitch 14b is timed so that the microswitch will not activate if plug blades 100 and 101 have not been sufficiently inserted but are still making contact with blade receivers 10. The microswitch contact points will activate, however, when plug blades 100 and 101 have been sufficiently inserted.

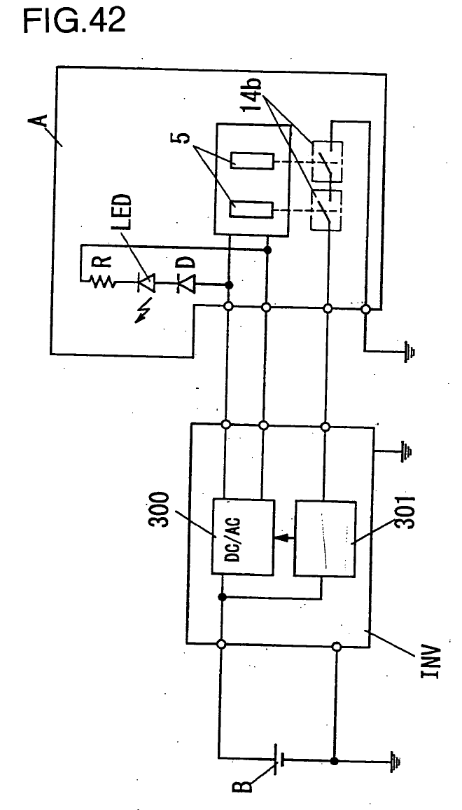

Furthermore, as previously noted, connector 14d provides an electrical connection from terminal 141 to blade receiver 10. As shown in FIG. 41, inverter circuit INV converts electrical power from vehicle-mounted battery ‘B’ into alternating current supplied to blade receiver 10 through connector 14d. Inverter circuit INV includes DC/AC conversion circuit 300 which converts direct current from battery ‘B’ into 100 volts alternating current, and controller 301 which is able to switch DC/AC conversion circuit ‘on’ and ‘off’. When the output from the microswitch circuit, in which both microswitches 14b are wired in series, assumes an ‘on’ state, controller 301 activates DC/AC conversion circuit 300 to supply 100 volts of alternating current, and will deactivate DC/AC conversion circuit 300 to stop the supply of AC current when the output from the series-wired microswitch circuit assumes an ‘off’ state. Thus, the output from the contact points of two microswitches 14b, which is applied through a series-wired circuit, is used to control the supply of power from inverter circuit INV to blade receivers 10. As a result of the previously described contact point output timing, it becomes possible to switch the supply of current from inverter circuit INV to blade receivers 10 ‘on’ or ‘off’ while plug blades 100 and 101 are still in contact with blade receivers 10. In other words, when plug blades 100 and 101 are inserted, inverter circuit INV supplies current to blade receivers 10 only when blades 100 and 101 are in electrically conductive contact with blade receivers 10. When plug blades 100 and 101 are withdrawn, current from inverter circuit INV to blade receivers 10 is turned off before blades 100 and 101 separate from blade receivers 10 to prevent electrical arcing between blade receivers 10 and plug blades 100.

Furthermore, a dependable plug blade detection function is provided because pivot lever 12 is formed as a rigid member able to consistently activate lever 14c of microswitch 14b even when plug blades 100 and 101 are inserted into blade insertion slots 5 at an angle.

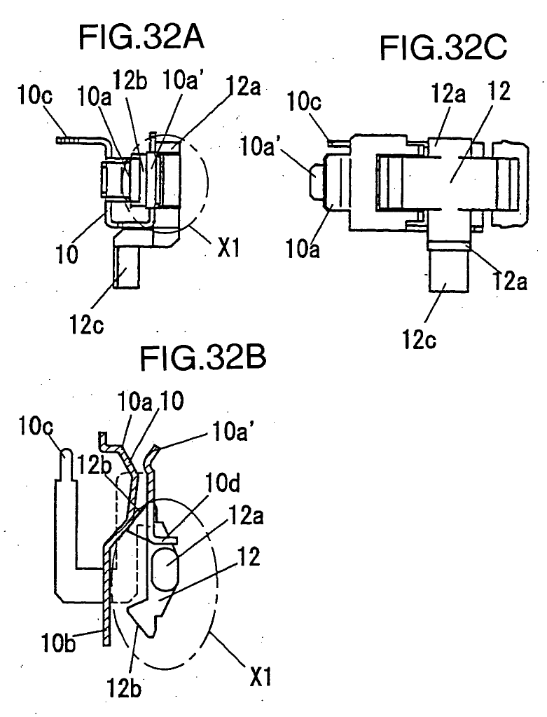

The structural elements of automotive electrical outlet box ‘A’ described in the present invention are explained below in detail. First, as shown in FIGS. 32a, 32b, and 32c, this embodiment describes pivot lever 12 as being disposed to the rear of blade spring 10a′ in the space between the two mutually facing blade receivers 10 at area X1 in the middle of body 2. Conventional designs place blade receiver 10 in area X1, but the placement of pivot levers 12 in area X1, as described in this embodiment, allows electrical outlet box ‘A’ to be made to smaller external dimensions.

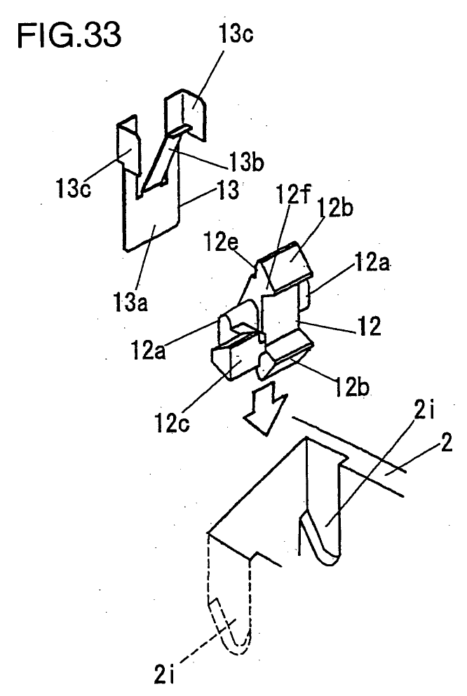

As shown in FIG. 33, pivot lever 12 is supported within pivot recesses 2i which are formed within the inner walls of body 2. The lower part of pivot shaft 12a resides within the lower part of each narrowing pivot recess 2i, the upper part of each recess 2i being open. The provision of pivot recesses 2i results in the formation of edge parts on the inner walls of body 2, and thus poses the possibility of slide faces 12f, which are located on the radial sides of pivot lever 12, hanging up on the edge parts while slide faces 12f slide against the internal wall. To prevent this, return spring 13, which presses against pivot lever 12, includes approximately L-shaped side flanges 13c which extend from each side of the front portion of base part 13a. Side flanges 13c cover the exposed surfaces of pivot recesses 2i and thus provide a smooth surface 12f against which slide faces 12f may slide.

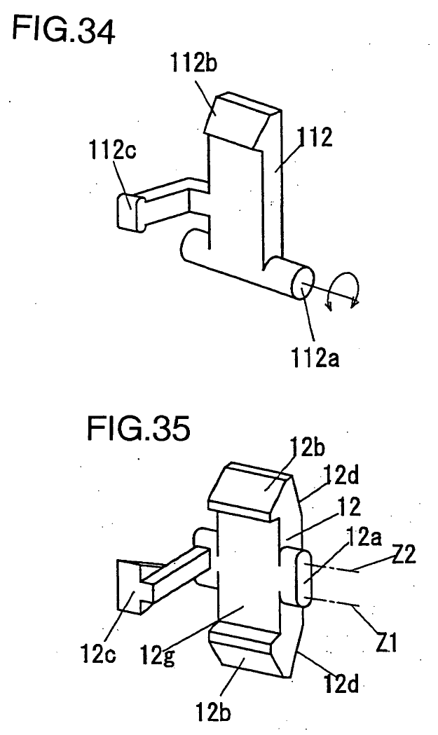

FIG. 34 illustrates a second configured construction of a pivot lever 112 which incorporates approximately round (in cross section) pivot shaft 112a. Inclined blade sensor surface 112b, which is formed on the end of a board like or planar member extending in the radial direction from the approximate axial center of shaft 112a, contacts plug blades 100 and 101 in order to transfer their movement to rotatably move pivot lever 112. Switch operating part 112c, which may be formed as an L-shaped member extending from the planar member, transfers the pivoting movement of pivot lever 12 to sensor switch 14b. The structure of pivot lever 112 precludes its common use for both plug blade 100 and 101 due to the placement of round pivot shaft 112a and the positional relationship between switch operating part 112c and pivot shaft 112a.

As previously noted, this embodiment specifies pivot lever 12 as being symmetrically formed in the fore and aft directions with respect to pivot shaft 12a which is an approximately barrel-shaped shaft. As shown in FIG. 35, one side of pivot shaft 12a is formed as partial shaft Z1 for use with plug blade 100, and the other end is formed as partial shaft Z2 for use with plug blade 101, thus forming a pivot lever configuration that may be commonly used for both plug blades 100 and 101. Moreover, cutout portion 12g is provided in the middle of the external side of pivot lever 12 in order to prevent contact with plug blades 100 and 101 when pivot lever 12 pivots. Also, as shown in FIG. 35, cutout portions 12d are provided on the internal side of each end of pivot lever 12 in order to prevent interference with body 2 when pivot lever 12 pivots.

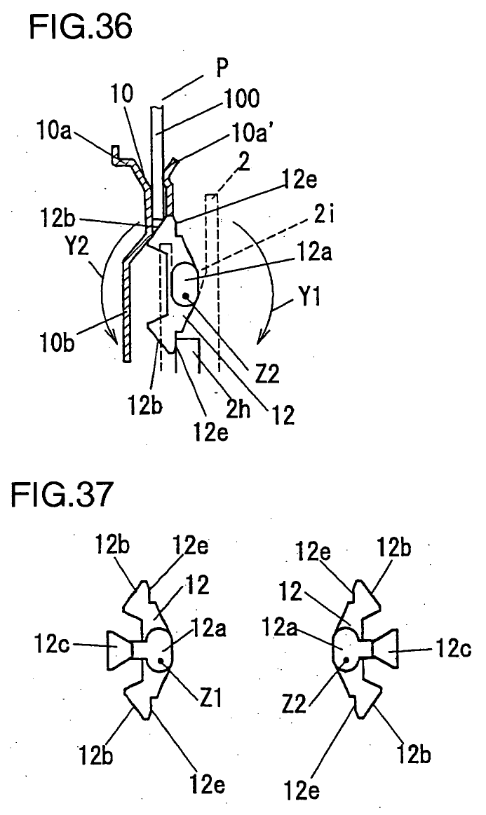

With respect to the FIG. 35 pivot lever 12 into which cutout portions 12d are formed, stop notch 12e (which can be seen in FIGS. 25a, 25b, 25c, and 36) is formed as a cutout part, L-shaped in cross section, on each end of pivot lever 12. When plug blades 100 and 101 are not inserted to blade insertion slots 5, pressure applied by return spring 13 holds the cutout surface of stop notch 12e against tab 2h which extends from the floor of body 2. Inserting the plug blades into blade receivers 10 (this operation is described with reference to FIG. 36 that shows plug blade 100 only) places the plug blade in contact with sensor surface 12b of pivot lever 12. The continued insertion of the plug blade is intended to rotate pivot lever 12 in the Y1 (clockwise) direction. However, there is a tendency for the plug blade to push pivot lever 12 in the Y2 (counter-clockwise) direction as a result of plug blade 100 contacting pivot lever 12 to the left of partial shaft Z1 of pivot shaft 12a and the relatively large amount of friction with which the plug blade slides against sensor surface 12b. This tendency is prevented by the surface of stop notch 12e contacting the lateral surface of tab 2h.

As shown in FIG. 37, stop notches 12e are also symmetrically formed with respect to pivot shaft 12a, thus allowing pivot shaft 12 to be flipped over for common use at either plug blade 100 or 101.

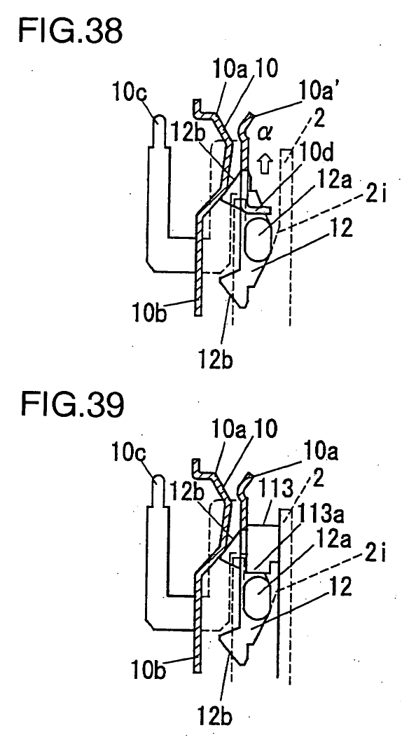

Moreover, blade receiver 10, as shown in FIG. 38, includes stop flange 10d which is an L-shaped structure bent outward at the rear end of blade spring 10a′ toward pivot lever 12 and located over the upper side of pivot shaft 12a to prevent vibration, shocks applied in the fore and aft direction, and the reactive force generated by the operation of lever 14c of microswitch 14b from dislodging pivot shaft 12a from pivot recess 2i, and to prevent malfunctions which may result in the inability to insert or detect the insertion of plug ‘P’ blades 100 and 101.

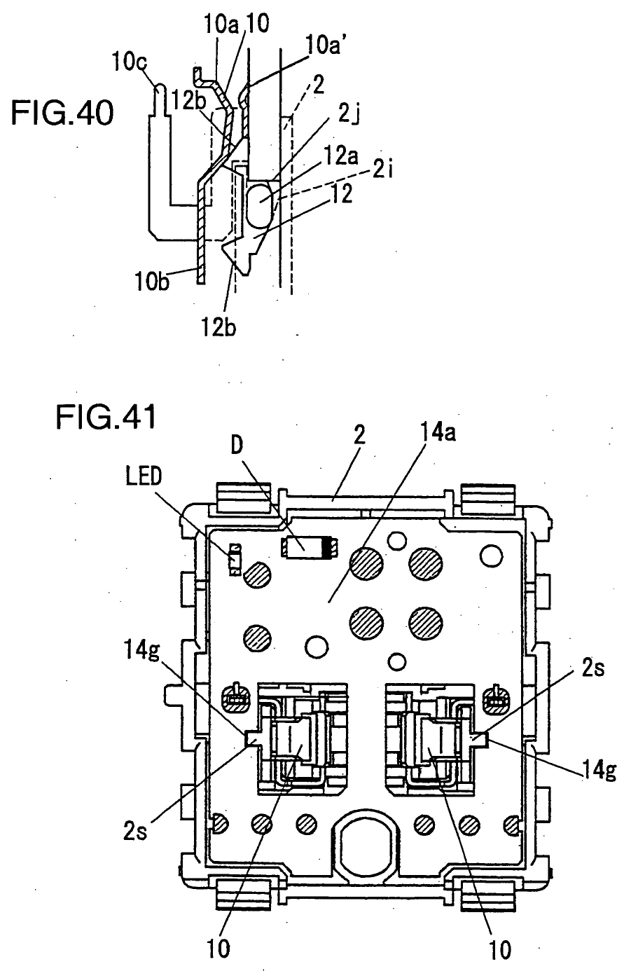

Although stop flange 10d is formed as an integral part of blade spring 10a′, a rearward extending part of return spring 113 (spring 113 being provided between the front of pivot lever 12 and body 2) may be located over the top of pivot shaft 12a as shown in FIG. 39. Furthermore, as shown in FIG. 40, stop flange 2j, which is a part of body 2, may also be located over the top of pivot shaft 12a in pivot recess 2i.

FIG. 41 illustrates printed circuit block 14 which is installed within body 2. The joining of tabs 2s, which project from divider wall b in body 2, to notches 14g, which are formed in the perimeter of orifices 14e in circuit base plate 14a, provides a convenient method of indexing printed circuit block 14 to body 2.

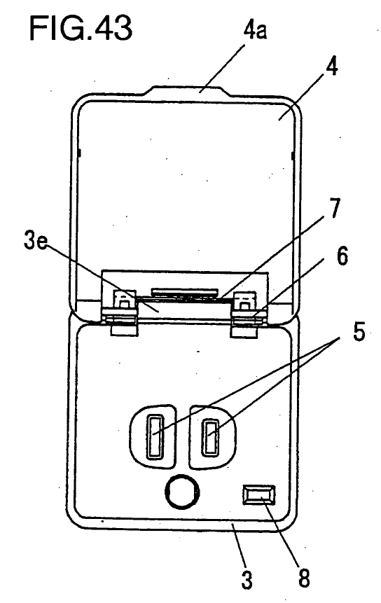

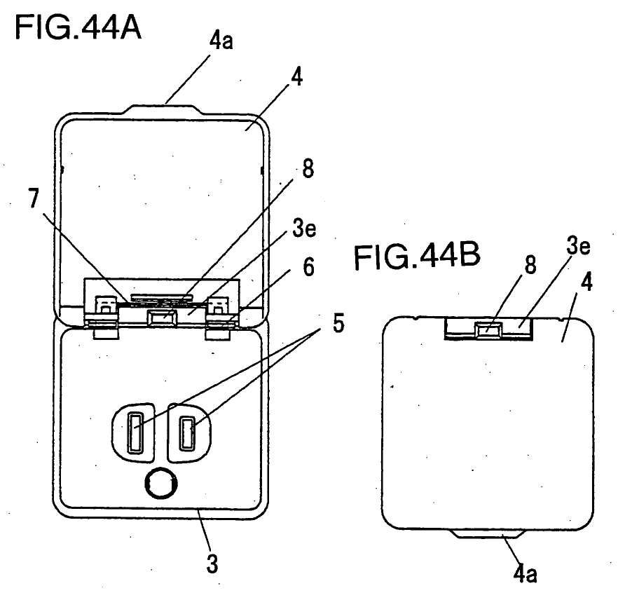

Furthermore, a current flow indicator LED and diode ‘D’ are provided on the front of circuit base plate 14a, and resistor ‘R’ is provided on the rear (see FIGS. 29 through 31). These three components are wired in series, with resistor ‘R’, between blade receivers 10 (see FIG. 42), thus resulting in the LED illuminating when 100V of alternating current is being supplied by inverter circuit INV. Transparent synthetic resin LED cover 8 (see FIGS. 1 and 3), is provided in window 3b which is formed within cover 3 opposite the LED, thus making it possible to verify the illumination of the LED. Although FIG. 3 shows LED cover 8 installed on the hinge support 3e side of cover 3, LED cover 8 may, as shown in FIG. 43, be installed on the side of cover 3 opposite to hinge support 3e. Also, as shown in FIG. 44, the installation of LED cover 8 to hinge support 3e allows the illumination of the LED to be verified with external cover 4 closed. Furthermore, external cover 4 may consist of a transparent or translucent material which allows the illumination of the LED to be verified even with external cover 4 closed.

Although the invention has been described with reference to an exemplary embodiment, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed. Rather, the invention extends to all functionally equivalent structures, methods, and uses such as are within the scope of the appended claims.

The present disclosure relates to subject matter contained in priority Japanese Application No. 2003-290717, filed on Aug. 8, 2003, which is herein expressly incorporated by reference in its entirety.

1. A vehicle mounted electrical outlet box comprising:
a case including a pair of plug blade insertion slots configured to receive a pair of plug blades inserted therein;
a pair of blade receiver portions electrically connected to an electrical power source of the vehicle, said blade receiver portions configured to contact press plug blades inserted into said case through said plug blade insertion slots;
a pair of plug blade detection mechanisms configured to detect the presence of each plug blade inserted into each said plug blade insertion slot; and
a pair of sensor switches, each said sensor switch including ‘on’ and ‘off’ switching contact points that operate in response to detection of the presence of a plug blade by said detection mechanism;
wherein said detection mechanisms are located between opposing blade receiver portions, and
said contact points of each sensor switch are electrically wired together in a series configuration.

2. The vehicle mounted electrical outlet box according to the claim 1, each said plug blade insertion detection mechanism comprising:
a pivot lever configured to pivot from the insertion of the plug blades into said plug blade insertion slots, each said pivot lever including a pivot shaft pivotably supported by said case, an inclined blade sensor surface through which plug blade insertion force is converted to a directional force that intersects the plug blade insertion direction, and a switch operating part driven by the directional force in order to operate said sensor switches when said pivot lever pivots,
wherein the axial ends of aid pivot shaft are formed in an approximately oval shape.

3. The vehicle mounted electrical outlet box according to claim 1, each said plug blade insertion detection mechanism comprising:
a pivot lever configured to pivot from the force with which the plug blades are inserted into said plug blade insertion slots, each pivot lever including a pivot shaft pivotably supported by said case, an inclined blade sensor surface through which the plug blade insertion force is converted to a directional force that intersects the plug blade insertion direction, and a switch operating part driven by the directional force in order to operate said sensor switches when said pivot lever pivots,
wherein said blade receiver part includes a stop flange that presses against the pivot shaft of the pivot lever in order to maintain the pivot lever in a fixed position.

4. The vehicle mounted electrical outlet box according to claim 1, each said plug blade insertion detection mechanism comprising:
a pivot lever configured to pivot from the force with which the plug blades are inserted into said plug blade insertion slots, each pivot lever including a pivot shaft pivotably supported by aid case, an inclined blade sensor surface through which the plug blade insertion force is converted to a directional force that intersects the plug blade insertion direction, and a switch operating part driven by the directional force in order to operate said sensor switches when said pivot lever pivots,
wherein a return spring applies pressure against said pivot lever in a direction opposite to that in which said pivot lever is pivotably moved by the plug blade insertion force.

5. The vehicle mounted electrical outlet box according to claim 1, each said plug blade insertion detection mechanism comprising:
a pivot lever configured to pivot from the force with which the plug blades are inserted into the plug blade insertion slots, each pivot lever including a pivot shaft pivotably supported by said case, and an inclined blade sensor surface that changes the plug blade insertion force to a directional force that intersects the plug blade insertion direction, and a switch operating part which is driven by the directional force in order to operate said sensor switches when said pivot lever pivots,
wherein a pivot recess is formed within an internal wall in said case in order to pivotably support said pivot shaft, and a metal plate is provided to cover and conceal said pivot recess in order to provide a surface on which the surface of said pivot lever, on which the pivot shaft is formed, may slide.

6. The vehicle mounted electrical outlet box according to claim 1, each said plug blade insertion detection mechanism comprising:
a pivot lever configured to pivot from the force with which the plug blades are inserted into said plug blade insertion slots, each pivot lever including a pivot shaft pivotably supported by said case, an inclined blade sensor surface that changes the plug blade insertion force to a directional force that intersects the plug blade insertion direction, and a switch operating part which is driven by the directional force in order to operate said sensor switches when said pivot lever pivots,
wherein a stop notch formed on said pivot lever contacts a surface within the case at a time when the plug blades are not present in the blade insertion slots, said contact occurring in a pivoting direction opposite to that induced by the directional force.

7. The vehicle mounted electrical outlet box according to claim 6, wherein said stop notch is formed on both ends of said pivot lever on the radial axis thereof.

8. The vehicle mounted electrical outlet box according to claim 1, each said plug blade insertion detection mechanism comprising:
a pivot lever configured to pivot from the force with which the plug blades are inserted into said plug blade insertion slots, each pivot lever including a pivot shaft pivotably supported by said case, an inclined blade sensor surface that changes the plug blade insertion force to a directional force that intersects the plug blade insertion direction, and a switch operating part driven by the directional force in order to operate a sensor switch, which is mounted to a base plate, when said pivot lever pivots from the directional force,
wherein said case and base plate are joined through a connection of mutually indexed recessed notches and projecting tabs formed on said case and base plate.

9. The vehicle mounted electrical outlet box according to claim 1, further comprising an indicator lamp to indicate when electricity is being supplied.

10. The vehicle mounted electrical outlet box according to claim 1, wherein said case is formed of a synthetic resin.

11. The vehicle mounted electrical outlet box according to claim 1, wherein blade receiver portions are made from a flexible electrically conductive material.

12. The vehicle mounted electrical outlet box according to claim 1, wherein said blade receiver portions are configured to press plug blades inserted into said case through said plug blade insertion slots.

13. The vehicle mounted electrical outlet box according to claim 1, wherein said blade receiver portions are configured to forcefully contact plug blade inserted into said case through said plug blade insertion slots.
